(19) United States
(12) Patent Application Publication
(10) Pub. No.: US 2026/0315944 A1
(43) Pub. Date: Oct. 15, 2026

(54) TOY

(71) Applicants: BANDAI CO., LTD., Tokyo (JP); PLEX CO., LTD., Tokyo (JP)

(72) Inventors: Yuna ARAI, Tokyo (JP); Haruka OTAKE, Tokyo (JP)

(21) Appl. No.: 19/467,705

(22) Filed: Feb. 2, 2026

(30) Foreign Application Priority Data
Feb. 5, 2025 (JP) 2025-017889

(51) Int. Cl. A63H 33/00

(52) U.S. Cl. CPC A63H 33/00

(57) ABSTRACT

A toy accommodating a movable body, the toy including a main body portion having an accommodation portion accommodating the movable body inside, wherein the accommodation portion is configured such that a first accommodation portion and a second accommodation portion are connected, the movable body is movable between the first accommodation portion and the second accommodation portion, the first accommodation portion and the second accommodation portion are configured such that any one of the first accommodation portion and the second accommodation portion makes the movable body visible through a front surface of the toy in a state where the movable body is accommodated, and another one of the first accommodation portion and the second accommodation portion makes the movable body invisible through the front surface of the toy in a state where the movable body is accommodated.

The contents of the following patent application(s) are incorporated herein by reference: NO. 2025-017889 filed in JP on Feb. 5, 2025.

### BACKGROUND

### 1. Technical Field

The present invention relates to a toy.

### 2. Related Art

Patent Document 1 describes a toy key holder containing a bead.

### RELATED ART DOCUMENTS

### Patent Document

Patent Document 1: Japanese Patent Application Publication No. 2022-163630

### BRIEF DESCRIPTION OF THE DRAWINGS

FIG. 1A illustrates an example of appearance of a toy corresponding to an embodiment.

FIG. 1B illustrates an example of the appearance of the toy corresponding to the embodiment.

FIG. 1C illustrates an example of an internal construction of the toy corresponding to the embodiment.

FIG. 1D illustrates an example of the internal construction of the toy corresponding to the embodiment.

FIG. 2A illustrates another example of appearance of the toy corresponding to the embodiment.

FIG. 2B illustrates another example of the appearance of the toy corresponding to the embodiment.

FIG. 2C illustrates another example of the internal construction of the toy corresponding to the embodiment.

FIG. 2D illustrates another example of the internal construction of the toy corresponding to the embodiment.

FIG. 3A illustrates a drawing for describing an example of a structure of an accommodation portion of the toy corresponding to the embodiment.

FIG. 3B illustrates a drawing for describing an example of the structure of the accommodation portion of the toy corresponding to the embodiment.

FIG. 4 illustrates a transition drawing showing an example of state transitions of the toy corresponding to the embodiment.

### DESCRIPTION OF EXEMPLARY EMBODIMENTS

Below, an exemplary embodiment of the invention will be described with reference to the drawings. Note that in each drawing, the same reference numerals indicate the same elements. In addition, in each drawing, up, down, left, and right directions with respect to the sheet of paper are used as the up, down, left, and right directions of the member in the present embodiment when providing the description in the text. Note that, in the embodiment of the present invention described below, plastic is described as an example of a material configuring a toy. However, the present invention is not limited to this, and metal, wood, glass, ceramic, or the like may also be used, or these materials may be combined to configure the toy.

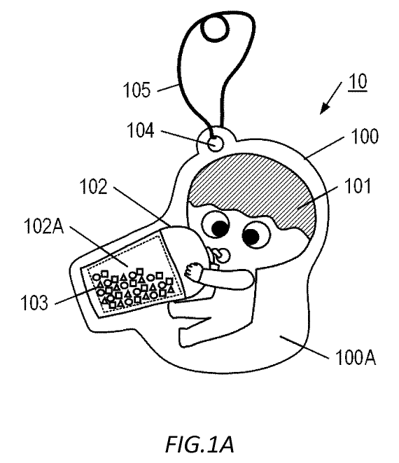

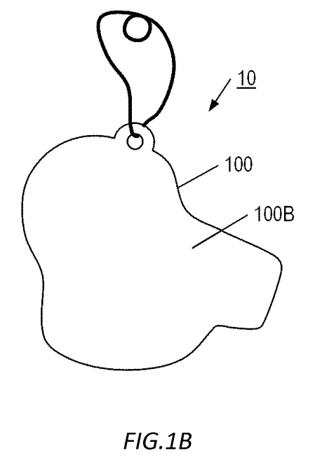

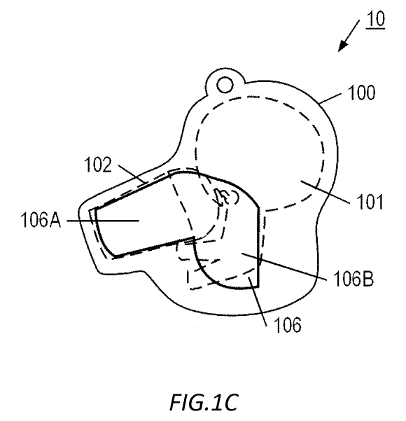

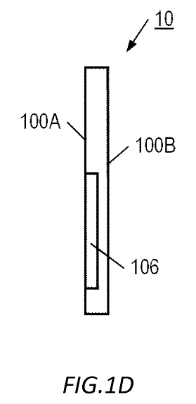

FIGS. 1A and 1B are drawings showing an example of appearance of a toy corresponding to an embodiment of the invention. In the present embodiment, a toy 10 has a main body portion 100, and a pattern 101 representing a predetermined character is printed on a front surface 100A shown in FIG. 1A. The front surface 100A and a back surface 100B of the main body portion 100 are configured entirely in a planar manner, or are configured by a flat surface. Note that the pattern 101 may be attached as a seal, or the pattern 101 may be configured by integral molding, such as a plastic model. Further, on the front surface 100A, a pattern 102 representing a predetermined accommodation body that is indicated to be the accommodation portion (the first accommodation portion) for accommodating the movable body 103 is printed, in a manner adjacent to the pattern 101A. In FIGS. 1A and 1B, a pattern 102 representing a water bottle as an accommodation body is printed, and the character of the pattern 101A is shown holding at least a part of the accommodation body of the pattern 102 and drinking the content of the accommodation body of the pattern 102. However, the pattern of the accommodation body is not limited to a water bottle, and may be a predetermined container such as a cup, a bowl, a bottle, a box, or the like. A portion (region 102A indicated by a dotted line) that matches a part of the pattern 102 of the front surface 100A is configured by a transparent or semi-transparent member. A combination of transparent and semi-transparent may be used, for example, the semi-transparent pattern may be formed in the transparent region (the same applies below). The range of the region 102A is set such that the end (peripheral portion) of the first accommodation portion inside the region 102A cannot be recognized from the outside. In this manner, the toy 10 is configured such that the presence of the movable body in the first accommodation portion is visible through the region 102.

The movable body 103 accommodated in the accommodation portion can be configured as a granular material, for example, as a bead. In addition to the bead, a solid object or a granular material such as glass, plastic, metal, wood, ceramic, or the like may be used, and a liquid substance such as water or slime may also be used. Further, the movable body 103 can have a shape or color indicating that the movable body 103 is the substance related to the pattern 101A of the character or the pattern 102 of the accommodation body. For example, if the pattern 102 has a shape in which the content is reminiscent of chocolate, the color of the movable body 103 can be a brown-based color. Alternatively, if the shape of the pattern 102 is reminiscent of a particular beverage, the color of the beverage, for example, red, green, yellow, or the like, can be used. Further, if the shape of the pattern 102 is reminiscent of a particular food (for example, cooked rice), the color of the pattern 102 can be set to the color of the food (in the case of cooked rice, white).

A hole 104 is provided in the main body portion 100, and the support member 105 for supporting the toy 10 can be attached to the hole 104. In the present embodiment, the support member 105 can be a string-shaped member. The material of the string-shaped member can be any of rubber, plastic, cotton, nylon, metal, leather, or the like. The main body portion 100 is supported by the support member 105, and can be attached (or suspended) to personal belongings of a user, such as a bag, a smartphone, or the like, for example. When the main body portion is attached to the personal belongings by the support member 105, gravity acts downward on the main body portion in FIGS. 1A and 1B. At this time, the movable body accommodated in the accommodation portion becomes stable in a form in which the main body portion 100 tilts and is held within the accommodation portion by the action of gravity.

The back surface 100B of the main body portion 100 illustrated in FIG. 1B is configured entirely in a planar manner or by a flat surface, and the first accommodation portion is not recognized on the back surface 100B. Although the present embodiment illustrates the configuration in which the movable body 103 can be visible from only one side, as shown in FIGS. 1A and 1B, the back surface 100B may also be configured similarly to the front surface 100A. That is, it may be configured such that the movable body 103 can be recognized on either the front surface or the back surface. In this case, it becomes possible to use it even when it is turned over. At that time, the character of the pattern 101 on the back surface 100B may be a character different from the character on the front surface 100A. In addition, the pattern 102 of the accommodation body can also be a pattern different from the pattern of the front surface 100A.

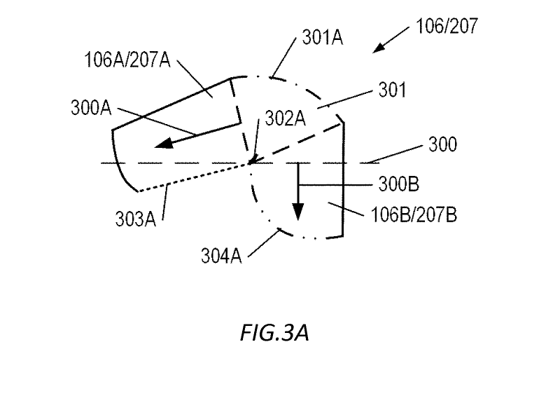

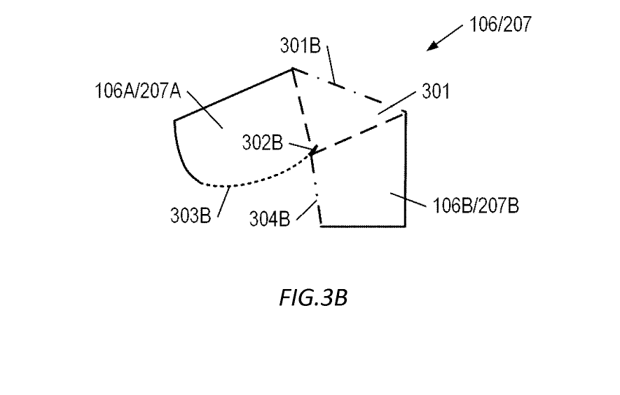

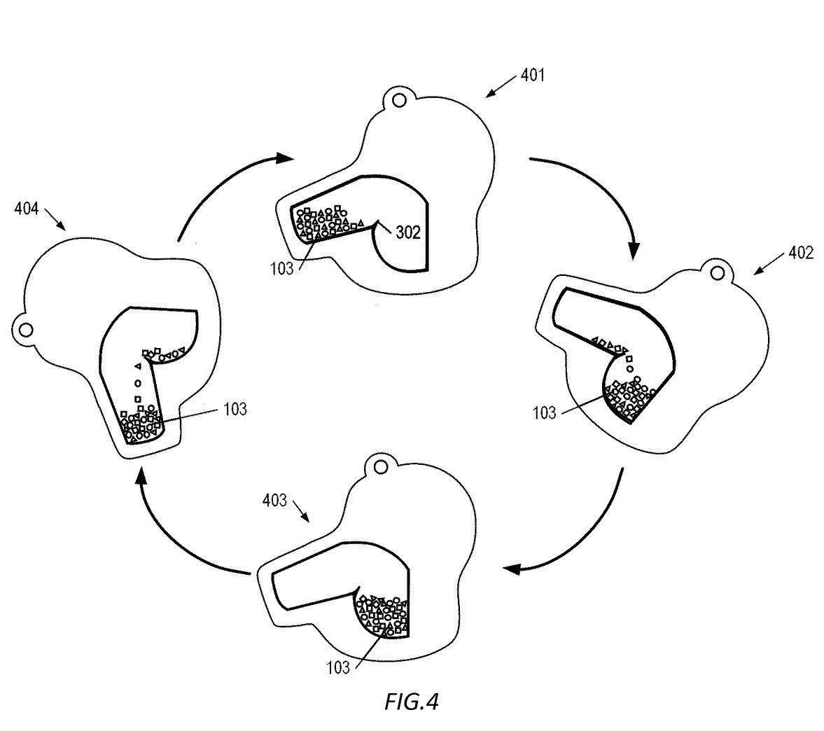

Next, with reference to FIGS. 1C and 1D, an example of the internal construction of the main body portion 100 of the toy 10 will be described. As illustrated in FIG. 1C, the main body portion 100 has the accommodation portion 106 inside. The dotted line 101 and the dotted line 102 on the main body portion 100 correspond to the pattern 101 and the pattern 102 shown in FIG. 1A. The position of the accommodation portion 106 corresponds to the position of the pattern 101 and the position of the pattern 102. Of the front surface 100A of the main body portion 100, all portions covering the accommodation portion 106, except for the region 102A, are configured from an opaque material. The accommodation portion 106 has two major regions, wherein one of the first accommodation portion 106A corresponds to the pattern 102, and the second accommodation portion 106B corresponds to the pattern 101. The first accommodation portion 106A and the second accommodation portion 106B are connected to each other, and are configured such that the movable body 103 accommodated inside can move back and forth between both accommodation portions. The configuration of the accommodation portion 106 will be described in further detail with reference to FIGS. 3A and 3B and 4.

As shown in FIG. 1D, the toy 10 is configured to have a certain thickness when viewed from the side. The accommodation portion 106 has a width (or a depth) capable of accommodating the movable body 103, but the width only needs to be sufficient so that one of the movable body 103 is movable freely, and it is desirable that the width is not sufficient for two or more movable bodies 103 to be movable. When the width is sufficient for two or more to be movable, it becomes possible for two or more to be positioned overlapping in the width direction of the accommodation portion 106, and even if the inside is visible in the region 102A, it is because the number of the movable bodies 103 that are recognized appears to be small. If the width of the accommodation portion 106 is sufficient for one of the movable body 103 to freely move, the movable body 103 will not be positioned overlapping in the width direction, and therefore, it becomes possible to recognize all of the movable bodies 103 accommodated in the accommodation portion 106.

In FIG. 1D, the accommodation portion 106 is positioned to be adjacent to the front surface 100A, which is in the case where there is an assumption that the inside is visible only from the front surface 100A side, and in the case of being visible from both sides, the accommodation portion 106 may be arranged to be adjacent to the back surface 100B as well.

In this manner, by adopting the configurations of FIGS. 1A, 1B, 1C, and 1D, in the toy 10, while the movable body 103 is positioned in the first accommodation portion 106A, since the region 102A is configured to be transparent or semi-transparent, the presence of the movable body 103 becomes visible and confirmable from the outside. Then, when the toy 10 is tilted and the movable body 103 is moved to the second accommodation portion 106B side, since there is no transparent region such as the region 102A, in the second accommodation portion 106B, the presence of the movable body 103 accommodated inside the second accommodation portion 106B becomes invisible (not confirmable) from the outside. At this time, on the front surface 100A of the toy 10, the character of the pattern 101A is shown to be drinking the content of the accommodation body of the pattern 102. Therefore, by tilting the toy 10 so that the movable body 103 moves from the first accommodation portion 106A to the second accommodation portion 106B, it becomes possible to produce a state in which the character drinks the content of the accommodation body and the content decreases. Further, after the movement of the movable body 103 is completed, the inside of the first accommodation portion 106A becomes empty, and the movable body 103 that has moved into the second accommodation portion 106B becomes invisible from the outside, therefore it is possible to produce the effect that the character has drunk up the content of the accommodation body without any sense of incongruity.

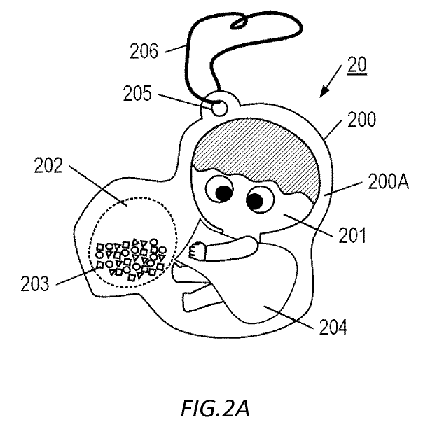

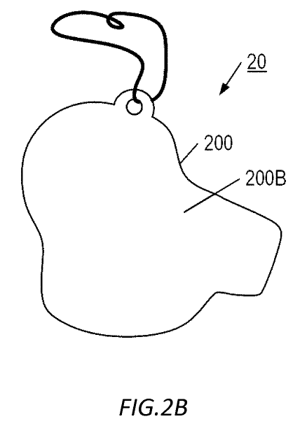

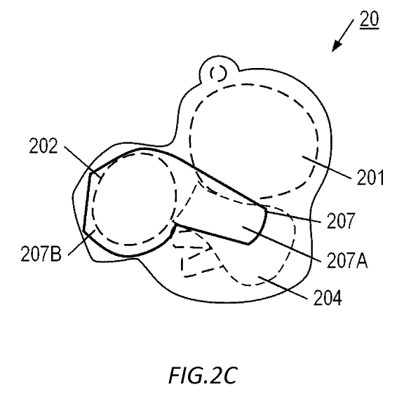

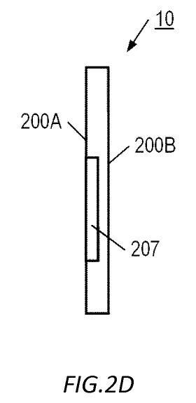

Next, FIGS. 2A, 2B, 2C, and 2D are drawings illustrating another example of the appearance of the toy corresponding to the embodiment of the invention and another example of the internal construction of the main body portion. The toy 20 has the main body portion 200, and on the front surface 200A shown in FIG. 2A, a pattern 201 representing a predetermined character is printed. The front surface 200A and a back surface 200B of the main body portion 200 are configured entirely in a planar manner, or are configured by a flat surface. On the front surface 200A, a pattern 204 representing a predetermined accommodation body that is indicated to be the accommodation portion (the first accommodation portion) for accommodating the movable body 203 is printed, in a manner superimposed on the pattern 201. In FIGS. 2A and 2B, the pattern 204 representing a bag is printed as the accommodation body, and the character of pattern 201 is shown taking out the content of the accommodation body of pattern 204, but the pattern of the accommodation body is not limited to a bag and may be the predetermined container such as a bottle or a box or the like.

A hole 205 is provided in the main body portion 200, and the support member 206 for supporting the toy 20 can be attached to the hole 205. The support member 206 can also be the string-shaped member similarly to FIGS. 1A and 1B. Other matters relating to the support member 206 are omitted from description because they are similar to those described in relation to the support member 105 in FIGS. 1A and 1B. The back surface 200B of the main body portion 200 shown in FIG. 2B is also configured as the flat surface, and the second accommodation portion is never recognized on the back surface 200B. Herein, as illustrated in FIGS. 2C and 2D, a configuration in which the movable body 203 is visible from only one side is illustrated, but the back surface 200B may also be configured similarly to the front surface 200A. The description of the other portions is omitted because it is similar to the description in relation to FIGS. 1A and 1B.

Next, with reference to FIGS. 2C and 2D, an example of the internal construction of the main body portion 200 of the toy 20 will be described. As illustrated in FIG. 2C, the main body portion 200 has the accommodation portion 207 inside. 204 and 202 indicated with dotted lines correspond to the pattern 204 and the pattern 202 shown in FIG. 2A. The position of the accommodation portion 207 corresponds to the position of the pattern 204 and the position of the pattern 202. Of the front surface 200A of the main body portion 200, all portions covering the accommodation portion 207, except for the region 202, are configured from an opaque material. The accommodation portion has two major regions, wherein one of the first accommodation portion 207A corresponds to the pattern 204, and the second accommodation portion 207B corresponds to the pattern 202. The first accommodation portion 207A and the second accommodation portion 207B are connected to each other, and are configured such that the movable body 203 accommodated inside can move back and forth between the both accommodation portions. The configuration of the accommodation portion 207 will be described later in further detail with reference to FIGS. 3A and 3B and 4.

The toy 20 in FIGS. 2A, 2B, 2C, and 2D is not configured such that the movable body 203 accommodated in the first accommodation portion 207A is visible from the outside. On the other hand, the dotted line region 202 corresponding to the second accommodation portion 207B is configured to be transparent or semi-transparent, and in the case where the movable body 203 is present in the second accommodation portion 207B, the movable body 203 is visible from the outside. The range of the region 202 is set such that the end (peripheral portion) of the second accommodation portion inside the region 207B cannot be recognized from the outside. In the toy 20 illustrated in FIGS. 2A, 2B, 2C, and 2D, the state in which the movable body 103 moves from the first accommodation portion 207A to the second accommodation portion 207B and the movable body 103 is taken out from the bag is shown.

As for the movable body 203, it is similar to that described in relation to FIGS. 1A and 1B. As shown in FIG. 2D, the toy 20 is configured to have a certain thickness when viewed from the side. The structure of the accommodation portion 207 can be described similarly in relation to FIG. 1D. Therefore, the description herein will be omitted.

By adopting the configurations of FIGS. 2A, 2B, 2C, and 2D in this manner, in the toy 20, while the movable body 203 is positioned in the first accommodation portion 207A, the presence of the movable body 203 becomes invisible (not confirmable) from the outside. When the toy 20 is tilted and the movable body is moved to the second accommodation portion 207B side, since the second accommodation portion 207B is configured to be visible from the outside via the region such as the region 202 that is transparent or semi-transparent, the presence of the movable body 203 accommodated inside the second accommodation portion 207B becomes visible (confirmable) from the outside. At this time, since a state in which the character of the pattern 201 is holding the bag of the pattern 204 is illustrated on the front surface 200A of the toy 20, by tilting the toy 20, the movement of the movable body 203 from the first accommodation portion 207A to the second accommodation portion 207B can produce a state in which the character takes out articles from the bag and the articles being taken out increase. After all of the articles have been taken out, it can be confirmed that the second accommodation portion 207B is in the state filled with the movable body 203.

In FIGS. 2C and 2D, the configuration of the accommodation portion 207 is configured as the reversed left-right configuration with respect to the accommodation portion 106 shown in FIGS. 1C and 1D, but the configuration may be configured similarly to the configuration of the accommodation portion 106. In that case, the first accommodation portion 106A corresponds to the pattern 202, and the second accommodation portion 106B corresponds to the pattern 204. And the movable body 203 accommodated in the first accommodation portion 106A is configured to be visible from the outside.

Next, with reference to FIGS. 3A and 3B, the configuration of the accommodation portions 106 and 207 will be described. FIG. 3A is a drawing illustrating an example of the configuration of the accommodation portions 106 and 207. FIG. 3B is a drawing illustrating another example of the configuration of the accommodation portions 106 and 207. The examples shown in FIGS. 3A and 3B assume a state in which the toy 10 is attached to the personal belongings by the support member 105 and gravity is applied downward.

In FIG. 3A, the accommodation portions 106 and 207 have the first accommodation portions 106A and 207A, and the second accommodation portions 106B and 207B, and are connected via the connecting region 301. The first accommodation portions 106A and 207A extend laterally (the first direction 300A) with respect to the connecting region 301. At this time, the first accommodation portions 106A and 207A extend laterally such that, rather than the end (the first end) on the connecting region side, the end (the second end) on the opposite side of the end (the first end) on the connecting region 301 side, is positioned on the lower side (closer to bottom) of the toy 10 and the toy 20, and further, the second accommodation portions 106B and 207B extend downward (in the second direction 300B) with respect to the connecting region 301. Herein, the second direction is closer to the vertical direction than the first direction, and the second direction substantially matches the vertical direction in the case where the toy 10 and the toy 20 are supported by the support member 105 and the support member 206. Further, the first direction 300A and the second direction 300B are the directions downward with respect to the horizontal direction 300.

The first accommodation portions 106A and 207A are configured such that the contour of the lower end portion 303A is linear. By configuring linearly in this manner, it becomes possible to smoothly move the movable bodies 103 and 203 from the first accommodation portions 106A and 207A to the second accommodation portions 106B and 207B when the toy 10 and the toy 20 are tilted. Further, even in the case where the movable bodies 103 and 203 are held in the first accommodation portions 106A and 207A, stable retention becomes possible.

The second accommodation portions 106B and 207B are configured in an arc shape such that the contour of the lower end portion 304A is curved and protrudes outwardly. By configuring in such an arc shape, after the movable bodies 103 and 203 have moved to the second accommodation portions 106B and 207B, it is possible to make it difficult for the movable bodies 103 and 203 to backflow to the first accommodation portions 106A and 207B. Simultaneously, it is also possible to make the move of the movable bodies 103 and 203 back to the first accommodation portions 106A and 207A smooth.

Moreover, the accommodation portions 106 and 207 are configured to include a portion (a first portion) where the lower end portion 303A of the first accommodation portions 106A and 207A and the lower end portion 304A of the second accommodation portions 106B and 207B intersect. The first portion may be configured to include the projecting portion 302A. The projecting portion 302A can be configured to protrude inside the accommodation portions 106 and 207 so that movement of the movable bodies 103 and 203 is not realized unless the toys 10 and 20 are tilted to a certain extent. It is desirable that an angle at which the lower end portion 303A and the lower end portion 304A intersect has an angle not exceeding 90 degrees. Further, the first portion is formed outward of the transparent region 102A or region 202, and the first portion is not recognized from outside.

The connecting region 301 is the region that connects the first accommodation portions 106A and 207A and the second accommodation portions 106B and 207B, but the contour of the upper end portion 301A is configured in an arc shape that protrudes outwardly. By configuring in an arc shape in this manner, when the movable bodies 103 and 203 move from the first accommodation portions 106A and 207A, the movable bodies 103 and 203 do not stop by, for example, getting caught in the connecting region 301, and it is possible to ensure the smooth movement.

Next, another example of the configuration of the accommodation portions 106 and 207 shown in FIG. 3B will be described. In FIG. 3B, the contours of the lower end portion 303B of the first accommodation portions 106A and 207A are configured in an arc shape protruding outwardly, which are different from FIG. 3A. Even when configured in an arc shape in this manner, it is possible to smoothly move the movable bodies 103 and 203 from the first accommodation portions 106A and 207A to the second accommodation portions 106B and 207B when the toys 10 and 20 are tilted. Further, even in the case where the movable bodies 103 and 203 are held in the first accommodation portions 106A and 207A, stable retention becomes possible.

The contour of the lower end portion 304B of the second accommodation portions 106B and 207B is configured to be linear rather than in an arc shape. Even if the configuration is made linear in this manner, by making the rising angle steep, it is possible, similarly to FIG. 3A, after the movable bodies 103 and 203 have moved to the second accommodation portions 106B and 207B, to make it difficult for the movable bodies 103 and 203 to backflow to the first accommodation portions 106A and 207B. Simultaneously, it is also possible to make the move of the movable bodies 103 and 203 back to the first accommodation portions 106A and 207A smooth.

Moreover, the accommodation portions 106 and 207 are configured to include a portion (a first portion) where the lower end portion 303B of the first accommodation portions 106A and 207A and the lower end portion 304B of the second accommodation portions 106B and 207B intersect. The first portion may be configured to include the projecting portion 302B. The projecting portion 302B can be configured to protrude inside the accommodation portions 106 and 207 so that movement of the movable bodies 103 and 203 is not realized unless the toys 10 and 20 are tilted to a certain extent. It is also desirable that an angle at which the lower end portion 303B and the lower end portion 304B intersect has an angle not exceeding 90 degrees.

The contour of the upper end portion 301A of the connecting region 301 is also configured in a linear manner. By configuring in a linear manner in this manner, when the movable bodies 103 and 203 move from the first accommodation portions 106A and 207A, the movable bodies 103 and 203 do not stop by, for example, getting caught in the connecting region 301, and it is possible to ensure the smooth movement.

As for the shapes of each end of the accommodation portions 106 and 207, it is possible to adopt any combination of the ends shown in FIGS. 3A and 3B.

Next, with reference to FIG. 4, an example of the state of movement of the movable body 103 when the toy 10 is rotated along the front surface 101A will be described. In FIG. 4, the toy 10 transitions in the order of a state 401, a state 402, a state 403, and a state 404, and then returns to the state 401. First, in the state 401, the movable body 103 is positioned in the first accommodation portion 106A. At this time, the movement of the movable body 103 is suppressed by the projecting portion 302A so that the movable body 103 does not easily move to the second accommodation portion 106B. Next, when the toy 10 is rotated clockwise and a transition to state 402 occurs, the movable body 103 moves over the projecting portion 302A and moves to the second accommodation portion 106B. When all of the movable bodies 103 have moved to the second accommodation portion 106B, the toy 10 is rotated counterclockwise to become the state 403. At this time, the movable body 103 is entirely accommodated in the second accommodation portion 106B and does not backflow into the first accommodation portion 106A. Herein, the projecting portion 302A also contributes to the suppression of the backflow. Next, when the toy 10 is rotated counterclockwise and transitions to the state 404, the movable body 103 moves from the second accommodation portion 106B to the first accommodation portion 106A, passing over the projecting portion 302A. When all of the movable bodies 103 have moved to the first accommodation portion 106A, the toy 10 is rotated clockwise to become the state 401.

Similarly to what is shown in FIG. 4, with respect to the toy 20, when the toy 20 is rotated counterclockwise while holding the movable body 203 in the first accommodation portion 207A, the movable body 203 gets over the projecting portion 302B, moves to the second accommodation portion 207B, and is held in the second accommodation portion 207B. Next, when the toy 20 is rotated clockwise, the movable body 203 gets over the projecting portion 302B and moves from the second accommodation portion 207B to the first accommodation portion 207A, and the movable body 203 is held in the first accommodation portion 207A.

As described above, according to the present embodiment, it is possible to configure the toy so as to have one accommodation portion in which the presence of the accommodated object can be visible from outside and the other accommodation portion in which the presence of the accommodated object is invisible from outside. On the front surface of the toy, a state where the character is drinking the accommodated object accommodated in the predetermined accommodation body, a state where the character is eating the accommodated object, and a state where the character is taking out the accommodated object are printed or drawn. Therefore, by tilting the toy so that the accommodated object moves from one accommodation portion to the other accommodation portion, or from the other accommodation portion to the one accommodation portion, it becomes possible to produce the state in which the accommodated object decreases as the character drinks or eats the accommodated object, as well as the state in which the accommodated object increases by taking out the accommodated object.

As described above, although embodiments of the invention have been described, the invention is not limited to the above embodiments, and various modifications and alterations are possible within the scope of the gist of the invention.

What is claimed is:

1. A toy accommodating a movable body, the toy comprising
a main body portion having an accommodation portion therein accommodating the movable body, wherein
the accommodation portion is configured such that a first accommodation portion and a second accommodation portion are connected, and the movable body is movable between the first accommodation portion and the second accommodation portion,
the first accommodation portion and the second accommodation portion are configured such that
any one of the first accommodation portion and the second accommodation portion makes the movable body visible through a front surface of the toy in a state where the movable body is accommodated, and
another one of the first accommodation portion and the second accommodation portion makes the movable body invisible through the front surface of the toy in a state where the movable body is accommodated.

2. The toy according to claim 1, wherein
in a case where the first accommodation portion is configured to be visible and the second accommodation portion is configured to be invisible,
the front surface of the toy corresponding to the first accommodation portion has a first configuration indicated to be the first accommodation portion, and
the front surface of the toy corresponding to the second accommodation portion has a second configuration indicated to be at least a part of a character holding at least a part of the first configuration.

3. The toy according to claim 1, wherein
in a case where the second accommodation portion is configured to be visible , and the first accommodation portion is configured to be invisible,
the front surface of the toy corresponding to the first accommodation portion has a first configuration indicated to be the first accommodation portion, and
the front surface of the toy corresponding to the second accommodation portion has a second configuration for indicating the movable body taken out from the first accommodation portion.

4. The toy according to claim 2, wherein the accommodation portion is configured to include a first portion at which a first end of the first accommodation portion and a second end of the second accommodation portion intersect.

5. The toy according to claim 4, wherein the first end is formed in a linear shape or an arc shape, and the second end is formed in a linear shape or an arc shape.

6. The toy according to claim 4, wherein the first portion includes a projecting portion that protrudes into the accommodation portion.

7. The toy according to claim 4, wherein an angle at which the first end and the second end intersect does not exceed 90 degrees.

8. The toy according to claim 4, wherein
the first accommodation portion and the second accommodation portion are connected via a connecting region,
the first accommodation portion extends in a first direction with respect to the connecting region, and
the second accommodation portion extends in a second direction, which is different from the first direction, with respect to the connecting region.

9. The toy according to claim 8, configured to be supportable by a support member.

10. The toy according to claim 9, wherein
in a state in which the toy is supported by the support member,
the first accommodation portion extends in the first direction such that a second end on an opposite side from the first end is positioned closer to bottom of the toy than a first end of a side of the connecting region.

11. The toy according to claim 10, wherein in a state in which the toy is supported by the support member, the second direction is closer to a vertical direction than the first direction.

12. The toy according to claim 11, wherein in a state in which the toy is supported by the support member, the second direction is substantially a vertical direction, and the first direction is a direction intersecting the second direction.

13. The toy according to claim 11, wherein in a state in which the toy is supported by the support member, the first direction and the second direction are directions downward from a horizontal direction.

14. The toy according to claim 11, further comprising
a hole for attaching the support member,
wherein the support member is a string-shaped member attached to the hole.

15. The toy according to claim 14, wherein an end of the connecting region on a side of the hole facing the first portion is configured in an arc shape.

16. The toy according to claim 8, wherein in a state in which the movable body is accommodated in the first accommodation portion, when the toy is rotated in a fixed direction along the front surface, the accommodation portion is configured such that the movable body moves from the first accommodation portion to the second accommodation portion via the connecting region.

17. The toy according to claim 1, wherein the accommodation portion has a bent shape.

18. The toy according to claim 1, wherein the movable body is a granular material formed of at least one of glass, plastic, metal, wood, or ceramic.

19. The toy according to claim 18, wherein the movable body has a shape related to a character associated with the toy.

20. The toy according to claim 1, wherein the movable body is a bead.
